(19) United States
(12) Patent Application Publication
(10) Pub. No.: US 2014/0015453 A1
(43) Pub. Date: Jan. 16, 2014

(54) Conductor Foil for a Lithium-Ion Cell, Lithium-Ion Accumulator and Motor Vehicle Comprising a Lithium-Ion Accumulator

(71) Applicants: Stephan Leuthner, Leonberg (DE); Thomas Woehrle, Stuttgart-Feuerbach (DE); Holger Fink, Stuttgart (DE); Joachim Fetzer, Bad-Ditzenbach (DE)

(72) Inventors: Stephan Leuthner, Leonberg (DE); Thomas Woehrle, Stuttgart-Feuerbach (DE); Holger Fink, Stuttgart (DE); Joachim Fetzer, Bad-Ditzenbach (DE)

(73) Assignee: Samsung SDI Co., Ltd., Yongin-si, Gyeonggi-do (KR)

(21) Appl. No.: 13/992,448

(22) PCT Filed: Nov. 22, 2011
(86) PCT No.: PCT/EP2011/070644

§ 371 Date: Sep. 16, 2013

(30) Foreign Application Priority Data
Dec. 10, 2010 (DE) 10 2010 062 852.2

(51) Int. Cl. H01M 2/26; B60L 11/18

(52) U.S. Cl. CPC H01M 2/26; B60L 11/18
USPC 318/139; 429/211

(57) ABSTRACT

A conductor foil for a negative electrode of a lithium-ion accumulator comprises at least one lithium-ion cell. The conductor foil comprises an aluminum foil both sides of which are covered by a metal layer consisting of copper or nickel. The disclosure further relates to a lithium-ion accumulator and to a motor vehicle comprising a lithium-ion accumulator.

The present invention relates to an outgoing conductor foil for a negative electrode of a lithium-ion rechargeable battery with at least one lithium-ion cell, to a lithium-ion rechargeable battery and to a motor vehicle with an electrical drive motor for driving the motor vehicle and to a lithium-ion rechargeable battery that is connected or can be connected to the electrical drive motor.

### PRIOR ART

Lithium-ion cells have at least one positive electrode and one negative electrode (cathode and anode, respectively), which can reversibly intercalate or deintercalate lithium ions (Li+). The terms lithium-ion cell, lithium-ion polymer cell, lithium-ion cell, battery, rechargeable battery and system are used largely synonymously.

Lithium-ion rechargeable batteries have to meet demanding requirements with respect to the gravimetric energy density (given in Wh/kg), in order for example to achieve the greatest possible ranges for vehicles driven by electric motors. The nominal capacity of a lithium-ion cell is determined by what are known as the active materials. However, in every lithium-ion cell there are also what are known as passive materials or “dead materials”, which consequently have an influence on the energy density of the lithium-ion cell. These include, for example, electrically conductive material, electrode binders, separators, outgoing conductor foils and the housing of the cell or of the rechargeable battery itself.

Outgoing conductor foils serve the purpose of electrically contacting and bonding the positive electrode and the negative electrode.

The construction of a lithium-ion cell is described for example in US 200080107961 A1.

In lithium-ion cells, aluminum foils are usually used as the outgoing conductor foil for contacting the positive electrode. On the negative electrode side, on the other hand, copper foils are used, since otherwise, if aluminum foils were used on the negative side, there would be an alloying of lithium and aluminum on account of the potential that is present. Generally, aluminum foils with a thickness of about 13 to 17 μm and copper foils of about 12 μm are used as outgoing conductor foils.

The use of copper foil as an outgoing conductor foil results in higher production costs. Moreover, this introduces a passive material, which has a higher crystallographic density in comparison with aluminum.

Thus, aluminum has a density of 2.7 g/cm³ and copper has a density of 8.9 g/cm³. Accordingly, the use of copper as an outgoing conductor foil has an adverse effect on the gravimetric energy density of the lithium-ion cell.

DE 103 44 637 A1 discloses an outgoing conductor for lithium-polymer batteries, applied to which is an electrically conductive primer layer that is free from carbon. In this case, the layer may consist, inter alia, of metals that have an improved conductivity in comparison with customary carbon-containing primers. No distinction is made between the described outgoing conductors with regard to suitability for the positive electrode or negative electrode. With preference, the outgoing conductors consist of aluminum and copper, with the result that the disadvantages already described above pertain when copper is used as the outgoing conductor.

### DISCLOSURE OF THE INVENTION

According to the invention, provided for the negative electrode side of a lithium-ion cell is an aluminum-based outgoing conductor foil which is provided on both sides with a metallic layer that prevents alloying with lithium ions during the operation of the lithium-ion cell. Preferably, the edges of the outgoing conductive foil are also coated.

Consequently, an outgoing conductor foil that is advantageously reduced in weight in comparison with the copper foils according to the prior art is obtained.

The weight advantages of the aluminum can consequently also be made usable for the negative electrode, and at the same time the disadvantage of the alloying due to lithium can be avoided.

Preferably, the production of the outgoing conductor foil according to the invention is not based on a customary outgoing conductor foil of aluminum for the positive side, but instead thinner aluminum foils are used, with the result that a customary thickness of about 12 μm is obtained after the coating with copper or nickel on both sides. For example, the copper layers may be respectively 1 μm thick, with the result that the thickness of the aluminum core is 10 μm. Other dimensionings of the layers or the total thickness of the outgoing conductor foil are possible of course, while the outer layers should be as thin as possible. Thus, a lower weight is achieved with the same foil thickness than in the case of a customarily used copper foil.

Preferably, the aluminum core foil is therefore thicker than the two outer layers together.

The outgoing conductor foil according to the invention is made up by applying a thin copper foil or layer to the aluminum foil on both sides. Alternatively, nickel may also be used for the surface coating.

The application of the thin layers of copper or nickel to the aluminum foil is preferably performed either

a) galvanically

b) by roll-bonded cladding or

c) by means of ion beam deposition.

In the case of all the methods, it must be ensured that the layer applied does not have any defects, since the intercalation of lithium in the aluminum foil situated between the two layers could nevertheless occur.

The outgoing conductor foils according to the invention are surprisingly stable over a long time in lithium-ion cells. Moreover, the outgoing conductor foils display an identical electrical performance and identical behavior under long-term cycling to that of a reference cell with a conventional outgoing conductor of copper.

One of the reasons why the properties of the outgoing conductor foils according to the invention were surprising was that detachment of the copper or nickel layer from the aluminum foil could not be ruled out a priori during the storage or operation of the cells. This would have been very disadvantageous for the electrochemical performance of the lithium-ion cell.

Particularly preferred are lithium-ion cells with outgoing conductor foils that have been produced by means of roll-bonded cladding or ion beam deposition, since they have achieved the best results in aforementioned comparative tests.

The subject matter of the present invention is also a lithium-ion rechargeable battery provided with this outgoing conductor foil and with at least one lithium-ion cell and also a motor vehicle with an electrical drive motor for driving the motor vehicle and a lithium-ion rechargeable battery that is connected or can be connected to the electrical drive motor.

Advantageous developments of the invention are specified in the dependent claims and described in the description.

### DRAWINGS

An exemplary embodiment of the invention is explained in more detail in the description which follows and on the basis of a drawing, in which:

FIG. 1 shows in a sectional side view an outgoing conductor foil according to the invention for the negative electrode of a lithium-ion cell.

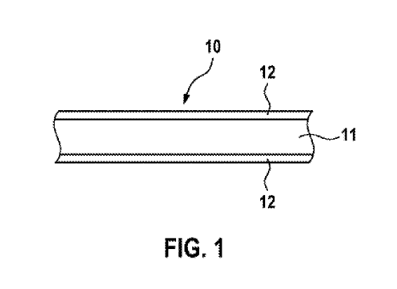

In FIG. 1, the construction of an outgoing conductor foil 10 for a lithium-ion cell (not represented) is shown. The outgoing conductor foil 10 has a core of an aluminum foil 11, which is covered on both sides by a metallic layer 12. The metallic layers 12 prevent lithium from alloying the aluminum foil during the operation of the lithium-ion cell. Preferably, the layer 12 consists of copper or nickel. Since it is intended with the outgoing conductor foil 10 according to the invention to obtain a weight-optimized outgoing conductor foil 10, the dimensioning of the aluminum foil 11 and of the two layers 12 should be set correspondingly, that is to say the layers 12 should be made as thin as possible.

1. An outgoing conductor foil for a negative electrode of a lithium-ion rechargeable battery having at least one lithium-ion cell, the outgoing conductor foil comprising:
an aluminum foil having a first side and a second side,
wherein the first side is covered with a first metallic layer and the second side is covered with a second metallic layer, and
wherein the first and second metallic layers comprise one of copper and nickel.

2. The outgoing conductor foil as claimed in claim 1, wherein the first and second metallic layers are applied galvanically.

3. The outgoing conductor foil as claimed in claim 1, wherein the first and second metallic layers are applied by roll-bonded cladding.

4. The outgoing conductor foil as claimed in claim 1, wherein the first and second metallic layers are applied by ion beam deposition.

5. The outgoing conductor foil as claimed in claim 1, wherein the aluminum foil has a thickness that is greater than a sum of thicknesses of the first and second layers.

6. A lithium-ion rechargeable battery comprising:
at least one lithium-ion cell having an outgoing conductor foil on a negative electrode side, wherein:
the outgoing conductor foil includes an aluminum foil having a first side and a second side,
the first side is covered with a first metallic layer and the second side is covered with a second metallic layer, and
the first and second metallic layers comprise one of copper and nickel.

7. A motor vehicle comprising:
an electrical drive motor for driving the motor vehicle; and a lithium-ion rechargeable battery including at least one lithium-ion cell having an outgoing conductor foil on a negative electrode side,
wherein the outgoing conductor foil includes an aluminum foil having a first side and a second side,
wherein the first side is covered with a first metallic layer and the second side is covered with a second metallic layer,
wherein the first and second metallic layers comprise one of copper and nickel, and
wherein the lithium-ion rechargeable battery is connected to the electrical drive motor.
